(19) United States
(12) Patent Application Publication
(10) Pub. No.: US 2016/0269883 A1
(43) Pub. Date: Sep. 15, 2016

(54) Automated Service Systems and Methods

(71) Applicant: Kapali Eswaran, South Ponte Vedra Beach, FL (US)

(72) Inventor: Kapali Eswaran, South Ponte Vedra Beach, FL (US)

(21) Appl. No.: 14/657,023

(22) Filed: Mar. 13, 2015

(51) Int. Cl. H04W 4/22; G06Q 10/00; H04W 4/02

(52) U.S. Cl. CPC H04W 4/22; H04W 4/025; G06Q 10/20

(57) ABSTRACT

A system and method for providing automated service includes a Provider App and a Customer App. The Provider App is provided by a Service Contractor for a plurality of Contracted Providers and includes related data of the Contracted Providers. The Customer App is provided to a Customer by the Service Contractor and includes Coverage Parameters for the Customer, whereby, the Customer App communicates directly to the Provider Apps, or via a Server, to provide service to the Customer via one of the Contracted Providers without the need for the Service Contractor intervening.

### TECHNICAL FIELD

Embodiments described herein pertain generally to systems and methods for providing automated emergency services, such as roadside assistance, repair of appliances and the like.

### BACKGROUND

Emergency roadside service (“ERS”) or assistance, or breakdown coverage, are services that assist drivers whose vehicles have suffered a mechanical or electrical failure or accident that leaves the driver stranded on the side of the road, i.e. roadside. Roadside service may be offered in the form of an insurance policy with premiums (for example, Geico® Auto Insurance), or in the form of a member subscription fee (for example, Verizon®). Some automobile manufacturers even offer roadside assistance for their customers for free for some time period after the purchase of a new vehicle (for example ONSTAR®, which can be renewed for a fee when the free period expires).

Businesses that contract to offer such ERS services, or the like, for a direct or indirect fee (“Premiums”) shall be referred to herein as Service Contractors. Emergency roadside service provided by Service Contractors may include, but is not limited to, jump starting an automobile, towing a vehicle, helping to change a flat tire, providing a small amount of fuel when a vehicle runs out of it, pulling out a vehicle that is stuck in snow, mud, sand, etc., helping people who are locked out of their cars, the like, etc.

Contracts for such emergency roadside services would/could determine whether service is limited to when the owner is driving the vehicle or to anyone who is driving the vehicle, provided the driver has been given permission by the owner. The term Customer will refer herein to any driver of the vehicle who is entitled to receive the emergency roadside service from a Service Contractor under the contract.

A Service Contractor may provide roadside service using their own crew or may contract such ERS services to a number of independent companies that would provide roadside service. The term Contracted Provider will refer herein to any company (including its own) that has been selected, approved and contracted to provide roadside service on behalf of the Service Contractor. A Contracted Provider may be associated with data that is specific to that Contracted Provider; such data would include but not limited to the name, identity and the services the Contracted Provider may be willing to provide and the types of vehicles that the Contracted Provider may be willing to provide the services on. For example, the services may include, but are clearly not limited to, towing, jump starting, flat tire repair, changing a flat tire, helping people who are locked out of the car (i.e. locksmith services), providing a small amount of fuel when a vehicle runs out of it, pulling out a vehicle that is stuck and combinations thereof. A Contracted Provider may, for example, also choose to work only on automobiles and not on trucks or motorcycles. Such data that is specific to a Contracted Provider is termed as Relevant Provider Data. The Service Contractor may keep the Relevant Provider Data updated.

The contract between the vehicle owner (“Customer”) and a Service Contractor may state service information of the customers such as kinds of roadside assistance that would be provided to customers of the vehicle, the vehicle identification number, make and model of the vehicle. The contract could also stipulate the maximum wait time (the time between the time that the Customer requests a service and a Contracted Provider arrives to provide the service). The contract could include an expiration date which is the date that the contract would expire unless renewed. In order to provide ERS, one would also need contact information (“addresses”) of the Contracted Providers in addition to owner specific and vehicle specific data. Such details of owner and vehicle specific data along with the contact information of Contracted Providers are termed Coverage Parameters. Addresses of Contracted Providers could include mobile phone numbers, physical addresses, URLs (web addresses) and the like.

Some common complaints from Customers with current emergency roadside service include the time it takes for the service to be provided. This time may include, but is not limited to, the time it takes on the phone to process and verify information with the Service Contractor, errors in verification by the clerk of the Service Contractor, the time it takes the Service Contractor to locate an available Contracted Provider who is ready, willing and able to provide the requested service on the specific type of vehicle, and/or the time it takes for the selected Contracted Provider to arrive at the scene where help is needed.

As such, there is clearly a need for a method or system for providing emergency roadside assistance that enhances the experience of the Customer. An example of such Customer enhancements could be the reduction in the time it takes for the service to be provided (“Wait Time”). Another example of such Customer enhancement could be reduction in human error such as sending an improper tow truck. Another example of such Customer enhancement could be a lesser deductible amount if such deductible clause is applicable. In the instant disclosure, we may refer to the reduction in Wait Time to denote all such enhanced Customer experiences.

The instant disclosure is designed to provide a system and method of automated emergency roadside assistance that addresses at least some of the above mentioned problems and may thus enhance the Customer experience. The disclosure may be extendable to provide a system and method of providing services in other contexts, such as repair of appliances.

### SUMMARY

Briefly described, in a preferred embodiment, the present system and method overcomes the above-mentioned disadvantages and meets the recognized need for such a system/method by providing automated emergency roadside service. The system for providing automated emergency roadside service (“ERS”) may include a Provider App and a Customer App. The Provider App may be provided by the Service Contractor for a plurality of Contracted Providers and may include related data of the Contracted Providers. The Customer App may be provided to a Customer by the Service Contractor and may include Coverage Parameters for the Customer. Whereby, the Customer App may communicate directly to the Provider Apps, or via a Server App (as described below in select embodiments), to provide ERS assistance to the Customer via one of said Contracted Providers without the need for the Service Contractor intervening.

Example embodiments of the automated service systems and methods disclosed herein may be provided in two parts: an App for the emergency roadside service provider (ERS provider) (Provider App) and an App for the driver who needs assistance (Customer App). The App for the ERS provider may be referred to herein as the Provider App and the App for the Customer may be referred to herein as the Customer App. The Apps acting together provide resolutions to the roadside assistance problems without the need for Service Contractor interventions. These Apps typically execute on mobile devices, but can also execute on personal computers. For example, the Customer App may execute on the insured person's (Customer's) mobile device and the Provider App may execute on the approved ERS provider's mobile device. When a Customer pays Premium for emergency roadside service, the Customer App on his mobile device is updated with coverage parameters. The Service Contractor may periodically update this Customer App with a list and related addresses of approved ERS providers. The Provider App, if not already turned on, may turn on the GPS location services of the mobile device which makes the location of the provider available for the Customer App. The Provider App also lets the provider (i) turn on or turn off the availability mode—whether the provider is available to provide assistance or not, (ii) set the kind of work he is willing to perform and (iii) set how far he is willing to travel from where he is to perform the work.

When an insured person (Customer) needs emergency roadside assistance, the person activates the Customer App on his mobile device. The person provides the vehicle identification and the type of problem for which he needs assistance. Without involving the Service Contractor clerk, this App validates the service coverage in relationship to the type of assistance that the person needs. The App may take into account the vehicle identification information in this verification process. Using the list and the addresses of the Provider Apps that may be stored in the Customer App, the Customer App then may broadcast to all Provider Apps its location, the vehicle identification and the type of problem that needs assistance. All of the Provider Apps whose availability mode is ON listen to the broadcast request from the Customer App, verify whether the ERS provider is a Qualified Provider for that request or not (qualification decision may depend on the parameters such as type of assistance needed, type of the vehicle needing assistance (which is deduced from the vehicle identification number) and the maximum distance the service provider is willing to travel (the distance may be computed, for example, from GPS data from the two Apps and maps; the qualification decision being made in conjunction with Relevant Provider Data stored as a part of Provider App); Non-Qualified providers may respond with a response of NO or would not respond at all. Qualified providers may reply with a two part response. The first part of the response may be YES, the approved ERS provider is willing to perform the service, and the second part of the response may include the expected time that the service provider may be able to reach the location of the person (which may be computed with assistance from mapping web services such as Google Maps, Yahoo Maps, Mapquest, etc.). The Customer App gathers the responses and selects a Targeted Provider as an approved ERS provider who has responded with a two part response whose first part is YES and whose second part is the least amount of expected time for the service provider to arrive to help the person. Having made the decision, the Customer App requests the selected Targeted Provider App to come and provide assistance. At this time, the Customer App may also send all other Provider Apps who had sent a YES response a message stating that they are not needed.

Utilizing the instant disclosure, the entire process of seeking emergency roadside assistance is by direct communication between the Apps, reducing the overhead for the service (insurance) companies, increasing the accuracy of details (type of service, vehicle type, location) and enhancing the experience of the Customer (insured).

The above summary has stated that the Customer App performs the verification, stores the list and data of the ERS providers as a part of the App and contacts Provider Apps directly. The above summary has also stated that the Provider App stores the Relevant Provider Data and performs qualification decision and then sends a response to the Customer App. But, it should be noted that either the Customer App or the Provider App or both could be designed to be thinner applications in which case the data and the decision making logic could be located as a web application in a Server and the Customer App and/or the Provider App communicate through the Server. The Server may be used herein to describe an application system that may operate on one or more computer platforms of hardware, software and data, i.e. the Server may be an application system operating on one or more computer platforms but acting as though there is only a single platform.

In select embodiments where both the Customer App and the Provider App are both thinner applications, the Coverage Parameters and Relevant Provider Data may be stored in the Server. The Provider Apps may contact the Server and inform the Server that they are available to provide service and their GPS location. When service is needed, the Customer App may contact the Server and provide the vehicle identification, the type of service needed, and the distress GPS location. The Server may verify the service (insurance) coverage and, if the coverage is current and correct, the Server may select the Targeted Provider, may inform the Targeted Provider to come and provide the service, and may inform the Customer App that the Targeted Provider is on the way.

Similarly, in select embodiments, the Customer App may be a thin application and the Provider App may be a thick application, or vice versa.

In select embodiments, when the Customer App is a thinner application and the Provider App is a thicker application, the Customer App may contact the Server with the request and provide the vehicle identification, the type of service needed, and the distress GPS location. The Server, using the Coverage Parameters stored in it, may verify the service (insurance) coverage, and, if the coverage is current and correct, the Server may broadcast the request to Provider Apps. Approved Providers may send a response to the Server with a two part response, the first part being YES and second part of the response from the YES responder is the expected time for the ERS provider to arrive to help the person. The Server then may select the Targeted Provider, may inform the Targeted Provider to come and provide assistance to the Customer. The Server also may inform the Customer that the Targeted Provider is on the way.

In select embodiments, when the Customer App is a thicker application and the Provider App is a thinner application, the Customer App using the Coverage Parameters stored in it verifies the service (insurance) coverage and if the coverage is current and correct, may contact the Server with the request and provide the vehicle identification, the type of service needed, and the distress GPS location. The Server using the Relevant Provider Data stored in it may first select Qualified Providers and then the Targeted Provider. The Server then may inform the Targeted Provider to come and provide assistance to the Customer. The Server also may inform the Customer that the Targeted Provider was on the way.

In the various embodiments in the above paragraphs, the Server may be considered an intermediary software application between a thick Customer App and a thick Provider App. The amount of logic and data that are a part of the Customer and Provider applications may decide how thick/thin the applications are.

### BRIEF DESCRIPTION OF THE DRAWINGS

The present systems and methods for automated emergency roadside service (“ERS”) will be better understood by reading the Detailed Description with reference to the accompanying drawings, which are not necessarily drawn to scale, and in which like reference numerals denote similar structure and refer to like elements throughout, and in which:

FIG. 1 is a prior art flow chart of an embodiment of a typical process for providing automated emergency roadside service.

FIG. 2 is a schematic diagram of an example embodiment of a system for providing automated service with direct communication between the Customer App and the Provider Apps.

FIG. 3 is a schematic diagram of an example embodiment of a system for providing automated service with communication between the Customer App and the Provider Apps through the Sever or Central App (“the Server”).

FIG. 4 is a flow diagram on an example embodiment of a method of providing automated emergency roadside service.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

Reference will now be made in detail to aspects of the present invention, examples of which are illustrated in the accompanying drawings, wherein like reference numerals refer to the like elements throughout. The aspects are described below in order to explain the present invention. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Example embodiments of the systems and methods of automated service disclosed herein include a sequence of steps or actions leading to a desired result and may be implemented as software. While it may be convenient to discuss such software as if embodied by a single program or application (“App”), most implementations will distribute the described functions among discrete (and some not so discrete) pieces of software. These pieces are often described using such terms of art as “Apps,” “programs,” “objects,” “functions,” “subroutines,” “libraries,” “.dlls,” “APIs,” and “procedures.” While one or more of these terms may be described in aspects of the present invention, there is no intention to limit the scope of the claims.

With respect to the software described herein, those of ordinary skill in the art will recognize that there exists a variety of platforms and languages for creating software for performing the methods outlined herein. Aspects of the present invention can be implemented using MICROSOFT VISUAL STUDIO or any number of varieties of C or Java or Objective C or Ruby on Rail or HTML, among others. However, those of ordinary skill in the art also recognize that the choice of the exact platform and language is often dictated by the specifics of the actual system constructed, such that what may work for one type of system may not be efficient on another system. It should also be understood that the systems and methods described herein are not limited to being executed as software on a microprocessor, but may be executed using other circuits. For example, the methods could be implemented on a digital signal processor, a FPGA, or with HDL (Hardware Design Language) in an ASIC.

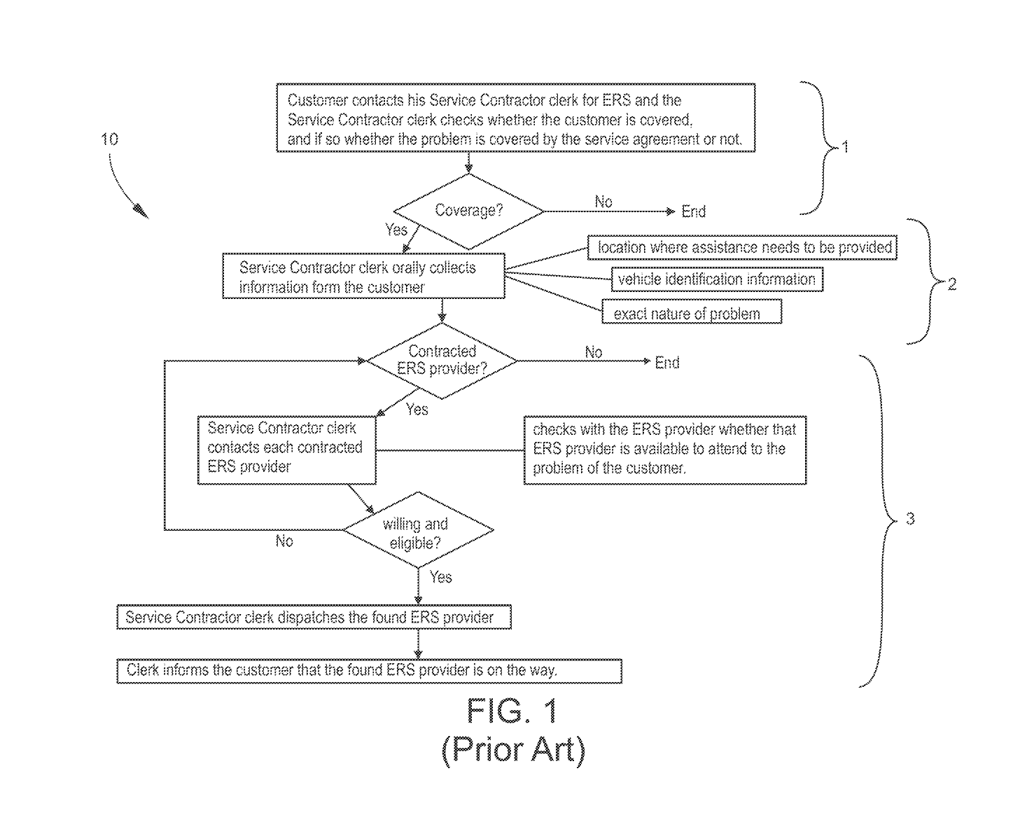

Referring now to FIG. 1, prior art typical process 10 for providing ERS is shown, as commonly known by those skilled in the art. In this known process 10, a Customer telephones the Service Contractor and orally arranging the ERS assistance over the phone with the clerk. As shown in the example, consider a Customer getting stuck roadside because of a problem, such as a flat tire. The following is a usual scenario of how the problem gets resolved and ERS assistance is provided.

Step 1: The Customer contacts his Service Contractor clerk for ERS. The Service Contractor clerk checks or verifies whether the Customer is eligible to receive assistance, and if so, whether the problem is covered by the contract with the Service Contractor or not.

Step 2: Once the coverage is verified, the Service Contractor clerk orally collects information from the Customer, like the location where assistance needs to be provided, vehicle identification information, exact nature of problem, etc. As an example, such location information might include the location is in the State of Georgia between exit 117 and exit 118 on Freeway I-75 heading south.

Step 3: The Service Contractor may have a pre-arranged relationship with a set of companies that could be dispatched to provide roadside service for assisting problems at the location of the person. The list may be broken into the expertise of the pre-arranged ERS providers, such as fix flat tire, tow the car etc. The Service Contractor clerk then contacts such pre-Contracted Providers one at a time and checks with the ERS provider whether that ERS provider is available to attend to the problem of the Customer. At times, the list may just contain the names and contact information of ERS providers and the Service Contractor clerk contacts the ERS providers and inquires their expertise and matches the expertise and the need. Once the Service Contractor clerk finds an ERS provider who is willing and eligible to help the Diver and attend to the problem, the Service Contractor clerk then dispatches the found ERS provider and then informs the Customer that the found ERS provider is on the way.

Referring to current typical process 10 shown in FIG. 1 and discussed above, as one can readily observe, there is a cost involved for the Service Contractor in these steps because of human intervention. Additionally, there is a delay in each of the steps which results in a possibility of a non-positive customer experience.

To address these issues, recently, with ubiquitous presence of mobile devices, several insurance companies have introduced software applications, or Apps, that may be installed in mobile devices. For example, GEICO® Insurance Company has developed a GEICO® Mobile App (currently available on Android® and Apple® markets). In the GEICO's® Mobile App, the App contacts the GEICO® clerk providing the clerk with the location of the person who wants emergency roadside service. The person and the clerk talk with each other and take additional steps. As such, the GEICO® Mobile App removes step 2 of the steps 1 through 3 of process 10 mentioned above as the App already has the information of the insured driver (Customer). Verizon® has deployed similar Apps. However, the known current Apps do not provide full automated services that completely eliminate the need for Service Contractor clerks in providing ERS assistance. As such, these mobile Apps can clearly be improved to enhance the Customer experience by reducing the wait time to receive ERS assistance.

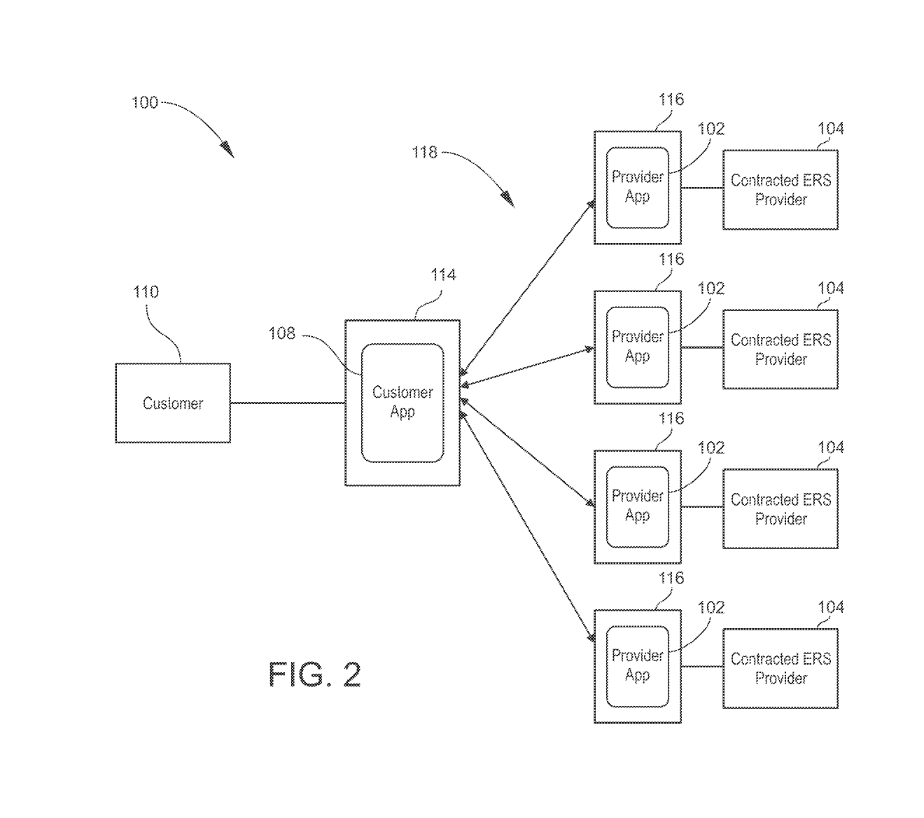

Referring now to FIG. 2 by way of example, and not limitation, therein is illustrated an example embodiment of system 100 for providing automated emergency roadside service (“ERS”) according to the instant disclosure, wherein system 100 generally provides automated ERS in the context of applications in mobile devices or personal computers (“App”). System 100 for providing automated ERS may include one or more Provider Apps 102 and Customer App 108. Such APPs 102 and 108 may be provided and maintained by the Service Contractor.

Each of Provider Apps 102 may be implemented on a computing device by one of a plurality of Contracted Providers 104. When a Contracted Provider 104 enters into a contract with the Service Contractor to provide ERS, Provider App 102 may be loaded on Contracted Provider's device 116 (mobile phone, tablet, PC etc).

When the owner of a vehicle contracts with (i.e., initiates a new contract or renews a existing contract) the Service Contractor for emergency roadside service, the owner and the drivers who might be operating the vehicle with owner's consent, i.e. Customers 110, may download Customer App 108 on their mobile devices 114 (mobile phone, tablet, PC, etc.) from the Service Contractor.

In an example embodiment, Apps 102 and 108 may be downloaded into mobile devices 116 and 114 respectively from the Service Contractor and may be configured to receive updates from the Service Contractor. Another feature of system 100 may be that the system may keep the Relevant Provider Data and Coverage Parameters updated on Provider Apps 102 and Customer App 108.

With select embodiments of system 100, the Coverage Parameters may be a part of Customer App 108 and the Relevant Provider Data may be a part of Provider Apps 102, whereby, Customer App 108 can communicate directly to Provider Apps 102 to provide ERS assistance to Customer 110 without the need for intervention by the Service Contractor. With this system and method, the entire process of seeking emergency roadside assistance may be by direct communication between Apps 102 and 108. This is shown with two-way direct communication 118. Use of two-way direct communication 118 eliminates the need for the Service Contractor to get involved, reducing the overhead for the Service Contractors, increasing the accuracy of details (such as type of service, vehicle type, location) and enhance the overall experience of Customer 110.

The related data of Contracted Providers 104 may include, but is clearly not limited to, the name, identity and the services each Contracted Provider 104 may be willing to provide. For example, the services may include, but are clearly not limited to, towing, jump starting, flat tire repair, changing a flat tire, helping people who are locked out of the car (i.e. locksmith services), providing a small amount of fuel when a vehicle runs out of it, pulling out a vehicle that is stuck, other like services, and combinations thereof. Related data of the Contracted Providers (the Relevant Provider Data) may be different for different Contracted Providers. Relevant Provider Data may include the types of vehicles that the provider may be willing to provide service on.

In select embodiments, Customer App 108 may be configured to update the Coverage Parameters of Customer 110 when he/she pays/renews his contract with the Service Provider, for example, by paying the Premium.

Provider Apps 102 and/or Customer App 108 may be executable on a mobile device and/or a personal computer. As shown in FIG. 2, in example embodiments, Customer App 108 may execute on the Customer's mobile device 114, and Provider App 102 may execute on Contracted Providers' mobile devices 116.

Provider Apps 102 may be, but are clearly not limited thereto, operable to: (i) turn on or off an availability mode for showing whether Contracted Provider 104 is available to provide assistance; (ii) set how far Contracted Provider 104 is willing to travel to perform the work; (iii) if not already turned on, turn on the GPS location service of the Contracted Providers' mobile device 116 which makes the provider location of Contracted Provider available for Customer App 108; (iv) decide whether a request for a specific roadside assistance can be fulfilled or not based on the request and the stored Relevant Provider Data; and/or (v) respond to a roadside assistance request from a Customer;

Customer App 108 may be, but is clearly not limited thereto, operable to: (i) activate when Customer 110 needs ERS assistance; (ii) input the Customer's vehicle identification information, if it is not a part of the Coverage Parameter; (iii) input the type of ERS problem for which Customer 110 needs assistance; (iv) validate that the Coverage Parameters meet the ERS problem taking into account the vehicle identification information; and/or (v) if not already turned on, turn on the GPS location service of the Customer's mobile device 114 which makes location of Customer 110 available for Provider Apps 102.

In operation, when Customer 110 needs emergency roadside assistance, Customer 110 can activate Customer App 108 and can input the vehicle identification if the identification is not a part of the Coverage Parameters and the type of problem for which Customer 110 needs assistance. Customer App 108 can then validate the Coverage Parameters of Customer 110 in relationship to the type of assistance that the person needs taking into account the vehicle identification information in this verification process. Using the addresses that are a part of the Coverage Parameters of Customer 110, Customer App 108 then can broadcast to all Provider Apps 102 its location, the vehicle information, and the type of problem that needs assistance. All Provider Apps 102 whose availability mode is on may then listen to the broadcast request from Customer App 108, interacting with Relevant Provider Data that is a part of the Provider App, and decide whether the request can be fulfilled or not. Contracted Providers 104 may reply with a two part response: the first part of the response may be yes or no depending on whether the request can be fulfilled or not; the second part of the response may be an expected time that the Contracted Provider 104 would be able to reach the location of Customer 110, whereby, when Customer App 108 may receive multiple yes responses, it compares the expected times of all such Provider Apps 102 and selects the target provider whose expected time is the least. Having selected the target provider, Customer App 108 may then send a request to Provider App 102 of the target provider to come and provide assistance. In example embodiments, Customer App 108 may also send all other Provider Apps 102 who had sent a yes response to the first part of the response a message stating that they are not needed.

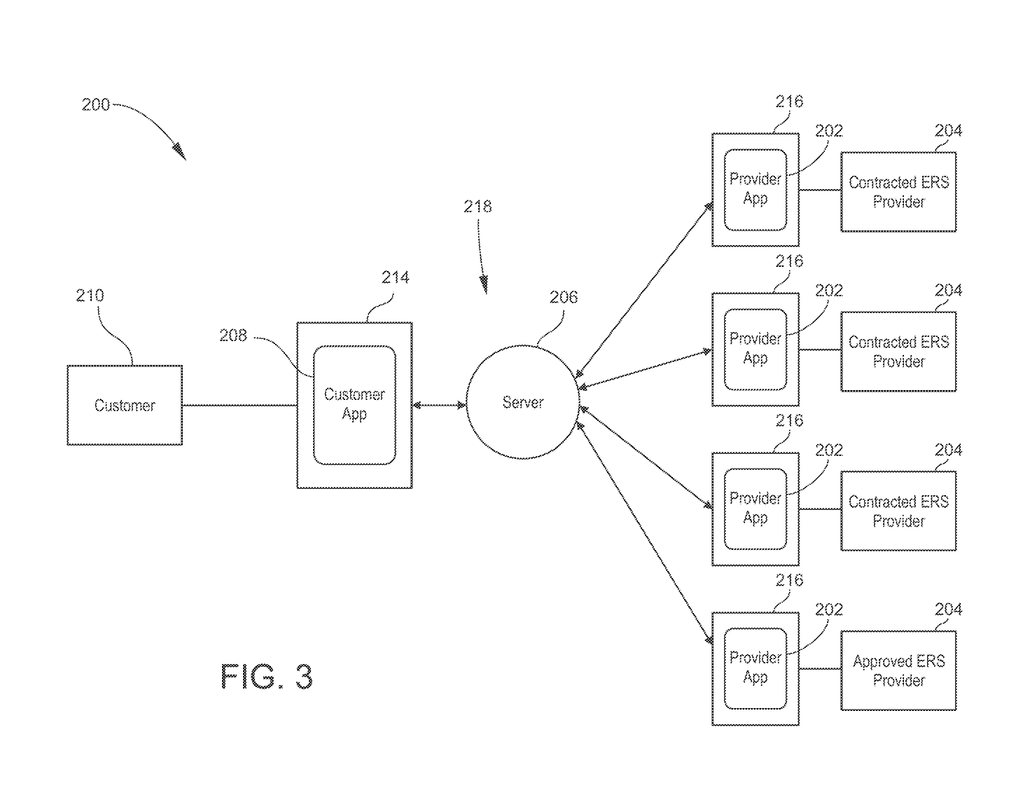

Referring now to FIG. 3, in another example embodiment, system 200 for providing automated ERS may generally include Provider App 202 for Contracted Providers 204, Customer App 208 for Customer 210 who might need ERS assistance, and Server 206. Server 206 may refer to an application system like Amazon® or Google® which operates on one or more computer systems comprising hardware, software and data, the application system working on one or multiple computer systems but acting as if there is only a single computer system. In this embodiment, Customer App 208 and Provider Apps 202 may be thinner in the sense that only a part or none of the Coverage Parameters may be a part of Customer App 208 and/or only a part or none of the Relevant Provider Data may be a part of Provider App 202. Server 206 may include Relevant Provider Data of Contracted Providers 204 and Coverage Parameters for Customer 210, whereby, Customer App 208 may communicate to Provider Apps 202 through Server 206 to provide ERS assistance to Customer 210 via one of Contracted Providers 204. In this embodiment, in addition to the data, the amount of the decision making logic that are a part of the Customer and Provider applications may decide how thick/thin the applications are. In this embodiment, the amount of data as well as the decision making logic is shared among the Customer App 208, the Provider App 202 and the Server 206.

This ERS assistance may be provided to Customer 210 via Customer App 208 communicating with Provider Apps 202 via or through Sever 206 without the need for the Service Contractor intervening. This communication through Server 206 is shown as reference number 218. As discussed above, similar to the embodiment shown in FIG. 2 of system 100 with direct communication 118 between Provider Apps 102 and Customer App 108, with the instant embodiment shown in FIG. 3 of system 200, the entire process of seeking emergency roadside assistance may be by communication between Provider Apps 202 and Customer App 208 through Server 206, thereby reducing the overhead for the Service Contractor, increasing the accuracy of details (such as type of service, vehicle type, location) and enhancing the experience of Customer 210. In the variation proposed in this example embodiment, Server 206 may include an intermediary software application between Customer App 208 and Provider Apps 202.

In an example embodiment, Server 206 is configured to update the Coverage Parameters when the vehicle owner initiates or renews coverage with the Service Contractor. Server 206 may also be operable to store the Relevant Provider Data of the Contracted Providers. Another feature of system 200 may be that the system may keep the Relevant Provider Data and Coverage Parameters updated.

In operation, utilizing system 200 with Server 206, when Customer 210 needs emergency roadside assistance, Customer 210 may activate Customer App 208 and may then input the vehicle identification and the type of problem for which he needs assistance. Server 206 may then validate the Coverage Parameters in relationship to the type of assistance that the Customer needs, taking into account the vehicle identification information in this verification process. If validated, Server 206 may then query the Relevant Provider Data of all Contracted Providers 204 and choose appropriate Contracted Providers 204 who can fulfill the request for the specific roadside assistance, and/or broadcast to all such appropriate Provider Apps 202 the customer location, the vehicle type, and the type of problem that needs assistance. All of the available Provider Apps 202 whose availability mode is on may listen to the broadcast request from Server 206, and may reply with a two part response: the first part of the response may be yes or no depending on the parameters including, but not limited to, the maximum distance Contracted Provider 204 may be willing to travel computed using the customer location and the provider location as data points (for example, by using a mapping service such as Google Map, Yahoo Map, Mapquest, etc.); the second part of the response may be an expected time that Contracted Provider 204 would be able to reach the location of the Customer 210, whereby, when Server 206 receives multiple yes responses, it compares the expected times of all such Provider Apps 202 and selects the target provider whose expected time is the least. Having selected the target provider, Server 206 may then request Provider App 202 of the target provider to come and provide assistance. In select embodiments, Server 206 may also send all other Provider Apps 202 who had sent a yes response to the first part of the response a message stating that they are not needed.

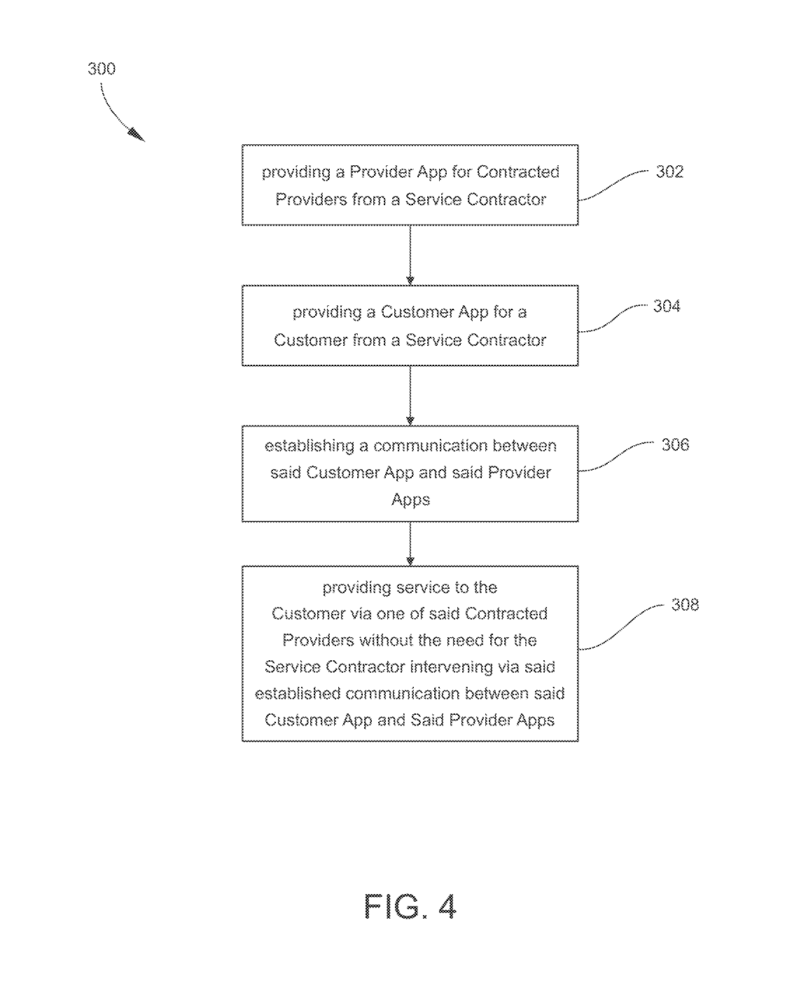

Referring now to FIG. 4, in use, method 300 of providing automated service, such as automated ERS, may be conducted utilizing any of the various embodiments of the system for providing automated service, as shown and described herein. Method 300 may generally include the steps of: step 302 of providing Provider App for Contracted Providers; step 304 of providing a Customer App for a Customer who might need ERS assistance; step 306 of establishing a communication between the Customer App and the Provider Apps; and step 308 of providing service (such as ERS assistance) to the Customer via one of the Contracted Providers without the need for intervention by the Service Contractor via the established communication between the Customer App and the Provider Apps. The communication may either be direct as shown in FIG. 2 or through a Server as shown in FIG. 3.

Referring now back to system 100 in FIG. 2, in example embodiments of method 300 of providing automated ERS, Provider App 102 may include Relevant Provider Data for each of the Contracted Providers 104, and Customer App 108 may include Coverage Parameters for Customer 110. In this embodiment, the established communication between Customer App 108 and Provider Apps 102 may be direct communication 118 between Customer App 108 and Provider Apps 102, whereby, the step of providing ERS assistance to Customer 110 via one of the Contracted Providers 104 without the need for intervention by the Service Contractor may be via the established direct communication 118 between Customer App 108 and Provider Apps 102.

In these example direct communication embodiments of method 300 of providing automated ERS, Provider App 102 of Contracted Provider 104 may be operable to: (i) turn on or turn off an availability mode for showing whether the Contracted Provider 104 is available to provide assistance or not; ii) set how far the Contracted Provider 104 is willing to travel from where Contracted Provider 104 is to perform the work; and/or (iii) and if not already turned on, turn on the GPS location service of the Contracted Providers' mobile device 116 which makes a provider location of the Contracted Providers 104 available for Customer App 108. Customer App 108 may be operable to: (i) activate when Customer 110 needs ERS assistance; (ii) input the Customer's vehicle identification information, if it is not a part of the Coverage Parameters; (iii) input the type of ERS problem for which Customer 110 needs assistance; (iv) validate that the Coverage Parameters meet the inputted ERS problem taking into account the inputted vehicle identification information; and/or (v) if not already turned on, turn on the GPS location service of the Customer's mobile device 114 which makes a customer location of Customer 110 available for Provider Apps 102.

In these example direct communication embodiments of method 300, when Customer 110 needs emergency roadside assistance, the method may further comprise the steps of: Customer 110 activating Customer App 108 and inputting the vehicle identification, if the vehicle identification is not a part of the Coverage Parameters, and the type of problem for which he needs assistance; Customer App 108 validating the Coverage Parameters in relationship to the type of assistance that Customer 110 needs including taking into account the vehicle identification information in this verification process; Customer App 108 retrieving the contact information (“addresses”) of Provider Apps 102 of the Contracted Providers 104 which are a part of Coverage Parameters; Customer App 108 then broadcasting to all such Provider Apps 102 its location, the vehicle identification, and the type of problem that needs assistance; all of Provider Apps 102 whose availability mode is on listening to the broadcast request from Customer App 108; Provider App 102 deciding whether the request for a specific roadside assistance can be fulfilled or not based on the request and the stored Relevant Provider Data; Contracted Providers 104 replying with a two part response: the first part of the response may be yes or no depending on the said decision in conjunction with the maximum distance the Contracted Provider 104 is willing to travel computed using a mapping service (like Google Map, Yahoo Map, Mapquest, etc.) using the customer location and the provider location as data points; and the second part of the response may be an expected time that the Contracted Provider 104 would be able to reach the location of Customer 110; when Customer App 108 receives multiple (meaning one or more) yes responses from Provider Apps 102, Customer App 108 comparing the expected times of all such Provider Apps 102 and selecting the target provider whose response time is the least; having selected the target provider, Customer App 108 requesting the Provider App 102 of the target provider to come and provide assistance. In example embodiments, Customer App 108 sends all other Provider Apps 102 who had sent a yes response to the first part of the response a message stating that they are not needed.

Referring now back to system 200 in FIG. 3, in example embodiments of method 300 of providing automated ERS, the method may further comprise the step of providing Server 206 that includes Relevant Provider Data of Contracted Providers 204 and Coverage Parameters for Customer 210. Wherein, established communication 218 between Customer App 208 and Provider Apps 202 may be through Server 206, whereby, the step of providing ERS assistance to Customer 210 via one of the Contracted Providers 204 without the need for intervention by the Service Contractor may be via the established communication 218 between Customer App 208 and Provider Apps 202 through Server 206.

In these example embodiments of method 300 that include Server 206, Provider Apps 202 may be operable to: (i) turn on or off an availability mode for showing whether Contracted Provider 204 is available to provide assistance or not; ii) set how far the Contracted Provider 204 is willing to travel from where the Contracted Provider 204 is to perform the work; and/or (iii) if not already turned on, turn on the GPS location service of the Contracted Providers' mobile device 216 which makes the location of the Contracted Providers 204 available for Customer App 208. Customer App 208 may be operable to: (i) activate when Customer 210 needs ERS assistance; (ii) input the Customer's vehicle identification information; (iii) input the type of ERS problem for which Customer 210 needs assistance; and/or (iv) if not already turned on, turn on the GPS location service of the Customer's mobile device 214 which makes a customer location of Customer 210 available for Provider Apps 202. Server 206 may be operable to: (i) store the kind of work Contracted Providers 204 are willing to perform on different types of vehicles; (ii) store how far the Contracted Providers 204 are willing to travel from where the Contracted Providers 204 are to perform the work; (iv) get the Customer's vehicle identification information; and (iv) validate that the Coverage Parameters meet the inputted ERS problem taking into account the vehicle identification information.

In these example embodiments of method 300 that include Server 206, when Customer 210 needs emergency roadside assistance, the method may further comprise the steps of: Customer 210 activating Customer App 208 and inputting the vehicle identification and the type of problem for which he needs assistance; Server 206 validating the Coverage Parameters in relationship to the type of assistance that Customer 210 needs including taking into account the vehicle identification information in this verification process; Server 206 deciding whether the request for a specific roadside assistance can be fulfilled or not based on the request and the stored Relevant Provider Data of Contracted Providers 204; Server 206 may decide which of the Contracted Providers 204 would fulfill the request; computing the expected times to reach Customer 210 by Contracted Providers 204 who could fulfill the request Server 206 choosing the Contracted Provider 204 as the target provider whose expected time to reach the location of Customer 210 would be least among all such expected times; and Server 206 informing the target provider to come and provide assistance. In example embodiments, Server 206 may also send all other Provider Apps 202 who had sent a yes response to the first part of the response a message stating that they are not needed.

In sum, the instant disclosure may be a software application that is in two parts: an app for the ERS provider (Provider App) and an app for the driver who might need assistance (Customer App). The Apps acting together provide resolutions to roadside assistance problems without the need for intervention from a Service Contractor. These Apps typically execute on mobile devices, but can also execute on personal computers. For example, the Customer App may execute on the Customer's mobile device and the Provider App may execute on the approved emergency roadside provider's mobile device or a personal computer mounted on the provider's vehicle. When an owner of a vehicle initiates or renews a contract with his/her Service Contractor, the Customer App on the mobile device of the owner and of drivers who might be operating the vehicle with owner's consent is updated with Coverage Parameters. The Service Contractor updates this Customer App with a list and addresses of approved emergency roadside assistance providers (ERS providers) when there are changes. The Service Contractor also loads and updates relevant data on the Provider App. The relevant data in Provider App may include the name, identity and the services that a provider is willing to provide (such as flat tire, locked out of the car etc.) and the type of vehicles that he is willing to service. If the GPS location service is not already turned on, the Provider App turns on the GPS location service(s) of the mobile device which makes the location of the provider available for the Customer App. In an alternative embodiment, customers or service providers may input their location data when GPS is non-functioning or not available. The Provider App also lets the provider (i) turn on or turn off the availability mode—whether the provider is available to provide assistance or not, and (ii) set how far he is willing to travel from where he is to perform the work.

When a Customer needs emergency roadside assistance, the Customer activates the Customer App on his mobile device. The Customer provides the vehicle identification and the type of problem for which he needs assistance. Without involving the Service Contractor clerk, this App validates the Coverage Parameters in relationship to the type of assistance that the Customer needs. The App may take into account the vehicle identification information in this verification process. If the GPS location service is not already turned on, the Customer App turns on the GPS location service(s) of the Customer's mobile device which makes the location of the Customer available. The Customer App then broadcasts to all Provider Apps a request consisting of its location, the vehicle identification and the type of problem that needs assistance. All of the Provider Apps whose availability mode is ON listen to the broadcast request from the Customer App, and qualify the request against the relevant data that is stored as a part of the Provider App. The ERS providers reply with a two part response based on the qualification. The first part of the response is YES or NO. This part of the response may depend on the relevant data which are the parameters such as type of assistance needed, type of the vehicle needing assistance (which could be deduced from the vehicle identification number) and the maximum distance the service provider is willing to travel (the distance may be computed using a mapping service, like Google Maps, Yahoo Maps, Mapquest, etc., using the GPS data from the two Apps). The second part of the response may be the expected time that the service provider would be able to reach the location of the person. The Customer App gathers the responses, selects a response whose first part is YES and whose second part is the least amount of expected time for the service provider to arrive to help the person, computed among all respondents whose response to the first part was yes. Having made the decision, the Customer App requests the selected Provider App to come and provide assistance. At this time, the Customer App may also send all other Provider Apps who had sent a YES response a message stating that they are not needed.

Utilizing the instant disclosure, the entire process of seeking emergency roadside assistance is by communication between the Apps, thereby reducing the overhead for the Service Contractor, increasing the accuracy of details (type of service, vehicle type, location) and enhancing the experience of the Customer (such as reduced wait time to get the service).

Although the disclosure has included the Customer App performing the verification, storing the data of the ERS providers as a part of the App, and contacting Provider Apps directly, it should be observed that the Customer App may be designed to be a thinner application (where only a part of the Coverage Parameters and only some of the logic are a part of the Customer APP) in which the Customer App contacts a web application of the Service Contractor instead, i.e. the Server. Similarly, the Provider App may be designed as a thinner application where only a part of the Relevant Provider Data of the Contracted Providers and only a part of the logic are a part of the Provider App, in which case logic such as the qualification of the Contracted Providers for a specific service request may form a part of the web application, i.e. the Server. In this scenario, the Customer App contacts the Server and provides the vehicle identification and the distress GPS location. The Server verifies the Coverage Parameters which are stored in the Server and, if the coverage is current and correct, the Server would qualify the request against the relevant data that is stored in the Server (qualified in the sense that the service provider is equipped to handle the type of service needed at that time). The Server may also broadcast the request to the Provider Apps of qualified service providers. Provider App then could contact the Customer App directly or indirectly through the Server. In this example embodiment, the Server could be considered an intermediary software application between the Customer App and the Provider App in which there is no need for intervention from Contract Providers. The Server may perform the verification and/or qualification.

Some common problems or complaints from Customers with current emergency roadside service include the time it takes for the service to be provided. This time may include, but is not limited to, the time it takes on the phone to process and verify information with the Service Contractor, errors in verification by the clerk of the Service Contractor, the time it takes the Service Contractor to locate an available Contracted Provider who is ready, willing and able to provide the requested service on the specific type of vehicle, and/or the time it takes for the selected Contracted Provider to arrive at the scene where help is needed. The instant disclosure is designed to provide systems and methods of automated emergency roadside assistance that addresses at least some of the above mentioned problems and may thus enhance the Customer experience.

In addition, even though this disclosure is presented here in terms of emergency roadside services, it is also applicable to other cases such as Home Appliance Insurance (also referred to as the Home Warranty Insurance). Insurance companies such as the American Home Shield offer such insurance. When an appliance breaks down, the insured customer would contact the Service Contractor, which, after verification of the insurance, dispatches an approved service provider skilled to fix the appliance and provide assistance to the customer. Apps (the insured person's app similar to that of Customer App and the service provider app similar to that of Provider App) can communicate with each other either directly or through a Server and provide assistance without human intervention. The terms appliance and service providers may loosely refer to all human entities. Such entities include, but are not limited to, appraisers, adjusters, agents, repair service providers who repair appliances such as dishwashers, HVAC and component repairers who fix roofs, fences, trees etc. In general terms, potential Service Seekers such as home owners would enter into a contract with Contract Companies such as insurance companies who would select, approve and contract with Service Entities that would provide service on behalf of Contract Companies to Service Seekers where Service Seekers communicate with Service Entities without a need for intervention from the Contract Companies. The system and the method described in this disclosure may be extended to all contexts where there are Service Seekers, Contract Companies and Service Entities, and where a Service Seeker and Service Entities communicate with each other without need for intervention from Contract Companies. As has been stated, the context and the service may be, but is not limited to, repair of appliances.

As such, the instant disclosure provides an example embodiment of a system for providing automated services. The automated services may be any services, including, but not limited to ERS, Home Appliance Insurance (also referred to as the Home Warranty Insurance), appraisers, adjusters, agents, repair service providers who repair appliances such as dishwashers, HVAC and component repairers who fix roofs, fences, trees etc., any Customers (i.e. any Service Seekers) who have a contract with Service Contractors (i.e. any Contract Companies that contract with such service seekers to provide services either by themselves or through contracted Service Entities (Contracted Providers) that provide such services), where a Service Seekers and a Service Entity communicate with each other without need for intervention from Contract Companies, the like, and/or combinations thereof. The Provider App may be provided by the Service Contractor (Contract Companies) for a plurality of Contracted Providers and may include Relevant Provider Data of the Contracted Providers (Service Entities). The Customer App may be provided to the Customer (Service Seeker) by the Service Contractor (Contract Company) and may include Coverage Parameters for the Customer, whereby, the Customer App may communicate directly (see FIG. 2) or through a Server (see FIG. 3) to the Provider Apps to provide services to the Customer via one of the Contracted Providers without the need for the Service Contractor intervening.

In select example embodiments, the Customer App may be configured to update the coverage parameters when the Customer pays a premium for the service.

In other select embodiments, the Provider App and the Customer App may be executable on a mobile device and/or a personal computer. In an example embodiment, the Customer App may execute on the Customer's (Service Seeker's) mobile device, and the Provider Apps may execute on the Contracted Providers' (Service Entities′) mobile devices and/or a personal computer.

In example embodiments, the Provider App may be operable to: (i) turn on or off an availability mode for showing whether the Contracted Provider is available to provide assistance or not; (ii) set how far the approved provider is willing to travel from where the Contracted Provider is to perform the work; (iii) if not already turned on, turn on a provider GPS location service of the Contracted Providers' mobile device which makes a provider location of the approved providers available for the Customer App; (iv) decide whether a request for a specific service can be fulfilled or not based on the request and the stored Relevant Provider Data; and/or (v) respond to a service request from the Customer.

In example embodiments, the Customer App may be operable to: (i) activate when the Customer needs service; (ii) input the Customer's service information, if it is not a part of the Coverage Parameters; (iii) input the type of service for which the Customer needs assistance; (iv) validate that the Coverage Parameters meet the inputted Customer's service information; and/or (v) if not already turned on, turn on a customer GPS location service of the Customer's mobile device which makes a customer location of the Customer available for the Provider Apps.

In operation, when the Customer needs service, the system may be operable to: allow the Customer to activate the Customer App and input the type of problem for which he needs assistance; validate the Customer's Coverage Parameters in relationship to the inputted type of assistance that the person needs taking into account the Customer's service information; and use addresses that are a part of the Customer's Coverage Parameters. The Customer App then may broadcast to all Provider Apps its customer location, Customer's service information, and the type of problem that needs assistance. All Provider Apps whose availability mode may be on may listen to the broadcast request from the Customer App; interact with Relevant Provider Data that is a part of the Provider App; decide whether the request can be fulfilled or not; and reply with a two part response. The first part of the response may be yes or no depending on whether the request can be fulfilled or not. The second part of the response may be an expected time that the service provider would be able to reach the location of the Customer, whereby, when the Customer App receives multiple yes responses, it may compare the expected times of all such Provider Apps and may select the target provider whose expected time is the least. Having selected the target provider, the Customer App may request the Provider App of the target provider to come and provide assistance.

The above narrations establish a need and an embodiment where a person in need of help uses a mobile application which directly or indirectly sends a request to a mobile application loaded in the devices of pre-approved entities that could provide the needed help and selects an entity that responds to the request.

The foregoing description and drawings comprise illustrative embodiments. Having thus described example embodiments, it should be noted by those skilled in the art that the disclosures are example only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. A system for providing automated services comprising:
a Customer mobile device comprising a Customer App provided to a Customer by a Service Contractor that includes Coverage Parameters for the Customer, the Customer App communicating directly or through a Server to Provider Apps to receive information for an available Contracted Provider to perform requested services, the available Contracted Provider determined without the need for the Service Contractor intervening by accessing:
location information of the mobile device; and
Contracted Provider assistance availability information provided by the Contracted Provider through a Provider App and received by the Customer App.

2. The system for providing automated service of claim 1, wherein said Customer App is configured to update the coverage parameters when the Customer pays a Premium for the service.

3. The system for providing automated service of claim 1, wherein said Provider App and said Customer App are executable on a mobile device and/or a personal computer.

4. The system for providing automated service of claim 1, wherein the Provider App is operable to:
(i) turn on or off an availability mode for showing whether the Contracted Provider is available to provide assistance or not;
(ii) set how far the Contracted Provider is willing to travel from where the Contracted Provider is to perform the work;
(iii) if not already turned on, turn on a provider GPS location service of the Contracted Providers' mobile device;
(iv) decide whether a service request can be fulfilled or not based on the request and the stored Relevant Provider Data; and/or
(v) respond to a service request from the Customer; and/or
the Customer App is operable to:
(i) activate when the Customer needs service;
(ii) input the Customer's service information, if it is not a part of the Coverage Parameters;
(iii) input the type of service for which the Customer needs assistance;
(iv) validate that the Coverage Parameters meet the inputted type of service; and/or
(v) if not already turned on, turn on a customer GPS location service of the Customer's mobile device which makes a customer location of the Customer available for the Provider Apps;
wherein when the Customer needs service, the system being operable to:
allow the Customer to activate the Customer App and input the type of service that is needed;
the Customer App validates the Customer's Coverage Parameters in relationship to the inputted type of service that the person needs;
using addresses that are a part of the Customer's Coverage Parameters, the Customer App then broadcasts to all Provider Apps a request with its customer location, Customer's service information, and the type of service that is needed;
all Provider Apps whose availability mode is on listen to the broadcast request from the Customer App, interacting with Relevant Provider Data that is a part of the Provider App, decide whether the request can be fulfilled or not, and reply with a two-part response:
the first part of the response is yes or no depending on whether the request can be fulfilled or not;
the second part of the response is an expected time that the service provider would be able to reach the location of the Customer;
whereby, when the Customer App receives multiple yes responses, it compares the expected times from all such Provider Apps and selects the target provider whose expected time is the least;
having selected the target provider, the Customer App requests the Provider App of the target provider to come to provide the needed service.

5. The system for providing automated service of claim 1, wherein the provided services being emergency roadside service and/or repair of appliances.

6. A system for providing automated emergency roadside service (“ERS”) comprising:
a customer mobile device for storing and executing a Customer App provided to a Customer by a Service Contractor that includes Coverage Parameters for the Customer;
said Customer App communicating directly to Provider Apps, the Provider Apps provided by the Service Contractor for a plurality of Contracted Providers that includes Relevant Provider Data of the Contracted Providers, to provide ERS assistance to the Customer via one of said Contracted Providers without the need for the Service Contractor intervening, the Customer App configured to select a Contracted Provider without the need for the Service Contractor intervening by accessing:
location information of the mobile device; and
Contracted Provider assistance availability information provided by the Contracted Provider through a Provider App and received by the Customer App.

7. The system for providing automated ERS of claim 6, wherein said Customer App is configured to update the Coverage Parameters when the Customer pays a Premium for the service.

8. The system for providing automated ERS of claim 6, wherein said Provider App and said Customer App are executable on a mobile device and/or a personal computer.

9. The system for providing automated ERS of claim 6, wherein: the Provider App is operable to:
(i) turn on or off an availability mode for showing whether the Contracted Provider is available to provide assistance or not;
(ii) set how far the Contracted Provider is willing to travel from where the Contracted Provider is to perform the work;
(iii) decide whether a specific roadside assistance request can be fulfilled or not based on the request and the stored Relevant Provider Data; and/or
(iv) respond to a roadside assistance request from the Customer; and/or
the Customer App is operable to:
(i) activate when the Customer needs ERS assistance;
(ii) input the Customer's vehicle identification information, if it is not a part of the Coverage Parameters;
(iii) input the type of roadside assistance needed;
(iv) validate that the Coverage Parameters meet the inputted ERS problem taking into account the vehicle identification information; and/or
(v) if not already turned on, turn on a customer GPS location service of the Customer's mobile device which makes a customer location of the Customer available for the Provider Apps;
wherein, when the Customer needs emergency roadside assistance, the system being operable to:
allow the Customer to activate the Customer App and input the vehicle identification and the type of roadside assistance needed;
let the Customer App to validate the Customer's Coverage Parameters in relationship to the inputted type of assistance that the person needs taking into account the vehicle identification information in this verification process;
using addresses that are a part of the Customer's Coverage Parameters, the Customer App then broadcasts to all Provider Apps a request with its customer location, the vehicle information, and the type of roadside assistance that is needed;
all Provider Apps whose availability mode is on listen to the broadcast request from the Customer App, interacting with Relevant Provider Data that is a part of the Provider App, decide whether the request can be fulfilled or not, and reply with a two-part response:
the first part of the response is yes or no depending on whether the request can be fulfilled or not;
the second part of the response is an expected time that the service provider would be able to reach the location of the Customer;
whereby, when the Customer App receives multiple yes responses, it compares the expected times from all such Provider Apps and selects the target provider whose expected time is the least;
having selected the target provider, the Customer App requests the Provider App of the target provider to come and provide assistance.

10. A system for providing automated emergency roadside service (“ERS”) comprising:
a Customer mobile device comprising memory for storing and a processor for executing a Customer App provided by a Service Contractor for a Customer; and
a Server that includes Relevant Provider Data of the Contracted Providers and Coverage Parameters for the Customer, said Customer App and Provider Apps communicating through said Server to provide ERS assistance to the Customer via one of said Contracted Providers without the need for a Service Contractor intervening, a provider of the ERS assistance selected by accessing:
location information of the mobile device; and
Contracted Provider assistance availability information provided by the Contracted Provider through a Provider App and received by the Customer App.

11. The system for providing automated ERS of claim 10, wherein said Server is configured to update the Coverage Parameters when the Customer pays a Premium for service.

12. The system for providing automated ERS of claim 10, wherein said Provider App and said Customer App are executable on a mobile device and/or a personal computer.

13. The system for providing automated ERS of claim 10, wherein the Provider App is operable to:
(i) turn on or off an availability mode for showing whether the Contracted Provider is available to provide assistance or not;
(ii) set how far the Contracted Provider is willing to travel from where the Contracted Provider is to perform the work; and/or
(iii) if not already turned on, turn on a provider GPS location service of the Contracted Providers' mobile device which makes a provider location available for the Server; and/or
the Customer App is operable to:
(i) activate when the Customer needs ERS assistance;
(ii) input the Customer's vehicle identification information, if it is not a part of the Coverage Parameters;
(iii) input the type of ERS assistance which the Customer needs; and/or
(iv) if not already turned on, turn on a customer GPS location service of the Customer's mobile device which makes a customer location of the Customer available for the Server; and
the Server is operable to:
(i) store the kind of work the Contracted Provider is willing to perform;
(ii) get the Customer's vehicle identification information;
(iii) validate that the Coverage Parameters meet the inputted ERS assistance request taking into account the inputted vehicle identification information;
(iv) decide which of the Contracted Providers whose availability mode is turned on qualify to fulfill the request;
(v) select the Service Contractor who has been qualified and whose expected time to provide service is the least as the target provider; and
(vi) inform the target provider to come and provide assistance;
wherein when the Customer needs emergency roadside assistance:
the Customer activates the Customer App and provides the vehicle identification and the type of roadside assistance needed;
the Server validates the Coverage Parameters in relationship to the type of assistance needed taking into account the vehicle identification information in this verification process;
the Server deciding whether the specific roadside assistance request can be fulfilled or not based on the request and the stored Relevant Provider Data of the Contracted Providers;
the Server deciding which of the Contracted Providers could fulfill the request;
the Server choosing the Contracted Provider as the target provider whose expected time to reach the location of the Customer would be least among all such expected times of all Contracted Providers who could fulfill the request;
whereby, the Server informing the target provider to come and provide assistance.

14. A method of automated service comprising:
providing a Customer App for storage on a mobile device of a Customer from a Service Contractor;
establishing a communication between said Customer App and Provider App;
selecting a provider of ERS assistance by accessing:
location information of the mobile device; and
Contracted Provider assistance availability information provided by the Contracted Provider through a Provider App and received by the Customer App; and
providing ERS assistance to the Customer via one of said Contracted Providers without the need for the Service Contractor intervening via said established communication between said Customer App and said Provider Apps.

15. The method of automated service of claim 14, wherein:
said Provider App includes Relevant Provider Data of the Contracted Providers;
said Customer App includes Coverage Parameters for the Customer; and
said established communication between said Customer App and said Provider Apps being a direct communication between said Customer App and said Provider Apps;
whereby, said step of providing service to the Customer via one of said Contracted Providers without the need for the Service Contractor intervening being via said established direct communication between said Customer App and said Provider Apps.

16. The method of automated service of claim 15, wherein the provided service is emergency roadside service (“ERS”), wherein:
the Provider App is operable to:
(i) turn on or off an availability mode for showing whether the Contracted Provider is available to provide assistance or not;
(ii) set how far the Contracted Provider is willing to travel from where the Contracted Provider is to perform the work;
(iii) if not already turned on, turn on provider GPS location service of the Contracted Providers' mobile device which makes a provider location of the approved providers available for the Customer App;
(iv) decide whether a request for a specific roadside assistance can be fulfilled or not based on the request and the stored Relevant Provider Data; and/or
(v) respond to a roadside assistance request from the Customer; and/or
the Customer App is operable to:
(i) activate when the Customer needs ERS assistance;
(ii) input the Customer's vehicle identification information, if it is not a part of the Coverage Parameters;
(iii) input the type of roadside assistance that the Customer needs;
(iv) validate that the Coverage Parameters meet the inputted assistance taking into account the vehicle identification information; and/or
(v) if not already turned on, turn on customer GPS location service of the Customer's mobile device which makes a Customer location of the Customer available for the Provider Apps.

17. The method of automated service of claim 16, wherein when the Customer needs emergency roadside assistance, the method further comprises the steps of:
the Customer activating the Customer App and inputting the vehicle identification and the type of assistance he needs;
the Customer App validating the Customer's Coverage Parameters in relationship to the inputted type of assistance that the person needs taking into account the vehicle identification information in this verification process;
using addresses that are a part of the Customer's Coverage Parameters, the Customer App broadcasting to all Provider Apps a request with its Customer location, the vehicle information, and the type of problem that needs assistance;
all Provider Apps whose availability mode is on listening to the broadcast request from the Customer App, interacting with Relevant Provider Data that is a part of the Provider App, deciding whether the request can be fulfilled or not, and replying with a two-part response:
the first part of the response is yes or no depending on whether the request can be fulfilled or not; and
the second part of the response is an expected time that the service provider would be able to reach the location of the Customer;
whereby, when the Customer App receives multiple yes responses, the Customer App comparing the expected times of all such Provider Apps and selecting the target provider whose response time is the least;
having selected the target provider, the Customer App requesting the Provider App of the target provider to come and provide assistance.

18. The method of automated service of claim 14 further comprising the step of providing a Server that includes Relevant Provider Data of the Contracted Providers, and Coverage Parameters for the Customer;
wherein, said established communication between said Customer App and said Provider Apps being through said Server;
whereby, said step of providing ERS assistance to the Customer via one of said Contracted Providers without the need for the Service Contractor intervening being via said established communication between said Customer App and said Provider Apps through said Server.

19. The method of automated service of claim 18, wherein the provided service is emergency roadside service (“ERS”), and wherein:
the Provider App is operable to:
(i) turn on or off an availability mode for showing whether the Contracted Provider is available to provide assistance or not;
(ii) set how far the Contracted Provider is willing to travel from where the Contracted Provider is to perform the work; and/or
(iii) if not already turned on, turn on provider GPS location service of the Contracted Providers' mobile device which makes a provider location of the approved providers available for the Customer App;
the Customer App is operable to:
(i) activate when the Customer needs ERS assistance;
(ii) input the Customer's vehicle identification information, if it is not a part of the Coverage Parameters;
(iii) input the type of ERS assistance that the Customer needs assistance; and/or
(iv) if not already turned on, turn on customer GPS location service of the Customer's mobile device which makes a Customer location of the Customer available for the Provider Apps; and
the Server is operable to:
(i) store the kind of work the Contracted Provider is willing to perform;
(ii) store how far the Contracted Provider is willing to travel from where the Contracted Provider is to perform the work;
(iii) get the Customer's vehicle identification information; and
(iv) validate that the Coverage Parameters meet the inputted ERS assistance taking into account the inputted vehicle identification information;
wherein when the Customer needs emergency roadside assistance, the method further comprises the steps of:
the Customer activating the Customer App and providing the vehicle identification and the type of assistance he needs;
the Server validating the Coverage Parameters in relationship to the type of assistance that the person needs taking into account the vehicle identification information in this verification process;
the Server deciding whether the request for a specific roadside assistance can be fulfilled or not based on the request and the stored Relevant Provider Data of the Contracted Providers;
the Server deciding which of the Contracted Providers could fulfill the request;
the Server choosing the Contracted Provider as the target provider whose expected time to reach the location of the Customer would be least among all such expected times of all Contracted Providers who could fulfill the request;
whereby, the Server informing the target provider to come and provide assistance.

20. (canceled)

21. (canceled)

22. (canceled)

23. (canceled)

24. (canceled)

25. (canceled)

26. (canceled)

27. (canceled)

28. (canceled)

29. The system of claim 1, wherein the Customer App further accesses a distance the Contracted Provider is willing to travel to provide the requested services to the Customer.

30. The system of claim 6, wherein the Customer App further accesses a distance the Contracted Provider is willing to travel to provide the requested services to the Customer.

31. The system of claim 10, wherein the Customer App further accesses a distance the Contracted Provider is willing to travel to provide the requested services to the Customer.

32. The method of claim 14, wherein selecting a provider of ERS assistance further accesses a distance the Contracted Provider is willing to travel to provide the requested services to the Customer.
